(19) United States
(12) Patent Application Publication
(10) Pub. No.: US 2024/0005269 A1
(43) Pub. Date: Jan. 4, 2024

(54) DETERMINING EFFICIENT ROUTES IN A COMPLEX SPACE USING HIERARCHICAL INFORMATION AND SPARSE DATA

(71) Applicant: Maplebear Inc. (dba Instacart), San Francisco, CA (US)

(72) Inventors: Benjamin Knight, Oakland, CA (US); Qi Xi, New York, NY (US); Saumitra Maheshwari, Sunnyvale, CA (US); Salmaan Ayaz, Seattle, WA (US)

(21) Appl. No.: 17/855,793

(22) Filed: Jul. 1, 2022

(51) Int. Cl. G06Q 10/08; G06Q 30/06

(52) U.S. Cl. CPC G06Q 10/087; G06Q 30/0633

(57) ABSTRACT

An online system performs a method. The method comprises obtaining historical pick data for items located in a warehouse, including data for each of the items picked and pick times between each of the items picked, and determining a taxonomy of items offered by the warehouse. The taxonomy identifies a plurality of product categories structured in a hierarchy, wherein each level of the hierarchy corresponds to a particular level of granularity of product data. The method further comprises applying the historical pick data to a machine learning model to generate pairwise relations between product categories at each level of the taxonomy and generating sequences of product categories based on the pairwise relations. An order for items offered by the warehouse is received and compared to the sequences for each level to generate a pick sequence for picking the items efficiently, which is outputted by the system to a mobile application.

### BACKGROUND

This disclosure relates generally to computer hardware and software for order fulfillment, and more specifically, to computer-implemented methods of determining efficient sequences for picking ordered items in a complex item space with sparse data.

When developing and implementing computer hardware and software for fulfilling orders for products located at a warehouse, determining the paths or sequences for picking up ordered items can be difficult due to a lack of data. For example, given a shopping list for a retail store, determining an efficient path/route for retrieving the items on the list may be difficult without a layout of the physical store. Multidimensional scaling (MDS), which models a physical layout based on time elapsed from one unique product number to the next, does not yield an efficient path/route, but merely allows one to infer approximate locations if given an immensely large amount of data, and must be used in conjunction with a traveling salesman-type algorithm. In addition to requiring a large amount of data and a large compute time, such an approach fails for scenarios where the starting point for picking orders may vary. For example, when some orders are picked by navigating a warehouse from left to right and others are picked from right to left, MDS predicts a physical layout that is inaccurate, ambiguous, or impossible to interpret, such as predicting the physical layout of items to be a circle.

Additionally, memory requirements of deploying MDS become unreasonably large at production scale. Assuming a typical store has 20,000 unique products, then MDS would require approximately 20,000\hat{ }2 item-by-item calculations or a large matrix of 400 million cells. This level of complexity will typically require a higher-end machine (>64 GB Ram) to run, if it can run at all, just for a single store. For applications where thousands of store locations are serviced, the level of compute required to perform these types of calculations is not feasible.

### SUMMARY

Described herein are computer systems and computer-implemented methods for inferring the most efficient pick path through a warehouse in the absence of ordinal information. To reduce the complexity of an item space, pairwise relations between items are calculated, generated, and/or predicted based on product categories as opposed to products themselves. In one or more embodiments, the product categories are structured in a hierarchical relationship, and computations are reduced by leveraging the levels of the hierarchy when generating sequences.

To infer the most efficient pick path through a warehouse, historical pick data for items picked in the warehouse is obtained. The historical pick data includes data for past orders fulfilled at the warehouse, including product data for each of the items picked and pick times between each of the items picked. A taxonomy of items offered by the warehouse is determined. The taxonomy identifies a plurality of product categories structured in a hierarchy, where each level of the hierarchy corresponds to a particular level of granularity of product data. For example, certain types of product data may correspond to a product category that applies to an entire department of the warehouse (e.g., produce department, frozen foods department, seafood department, etc.), to a particular aisle within a department (e.g., vegetable aisle, fruit aisle, frozen pizza aisle, etc.), or to a specific section of an aisle (e.g., carrots, strawberries, avocados, etc.), and so on. Using the historical pick data, pairwise relations between product categories at each level of the hierarchy are calculated, generated, or predicted using machine learning and used to generate sequences of product categories for each level. To generate the pairwise relations, the historical pick data is applied to a machine learning model, which may be a linear model used to infer weights for an individual observation from the historical pick data. For example, if a shopper texts a customer between items, the time difference between picks may not be reflective of the time of travel between product categories, and thus, may be down weighted.

When an order for items offered by the warehouse is received, the order is compared to at least one of the sequences of product categories to generate a pick sequence for the order. The pick sequence is then outputted. For example, the pick sequence may be rendered as instructions on a client device informing a shopper the order in which the items should be picked to fulfill the order most efficiently.

### BRIEF DESCRIPTION OF THE DRAWINGS

FIG. 1 is a block diagram of a system environment in which an online system, such as an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 is a flowchart of one embodiment of a method for determining efficient sequences for picking ordered items.

FIG. 6A is an illustration of pairwise relations between product categories, according to one or more embodiments.

FIG. 6B is an illustration of selecting a first product category in a sequence, according to one or more embodiments.

FIG. 6C is an illustration of generating a sequence, according to one or more embodiments.

FIG. 6D is an illustration of generating a sequence, according to one or more embodiments.

FIG. 6E is an illustration of generating a sequence, according to one or more embodiments.

FIG. 6F is an illustration of generating a sequence, according to one or more embodiments.

FIG. 7 is an illustration of estimating a ranking, according to one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

For an online concierge system, retail partners may provide item location data that contains no information about where items in a store/warehouse are located relative to one another. A shopper fulfilling such an order from the system may only be given broad locations as to where ordered items can be found, but no indication of how to shop for them. This is problematic for directing the shopper through the warehouse in an efficient manner. Especially when a shopper is a novice at fulfilling orders at a particular warehouse, the shopper may not know the most efficient route for picking items there. Shoppers that accrue experience fulfilling multiple orders from the same warehouse may gradually learn which path saves the most time. However, not all shoppers of an online concierge system may be experienced. To better enable shoppers to navigate a store quickly, a method of inferring the hidden ordinal relationships between areas within a store is needed, in particular, by creating an efficiently sorted shopping list from pure product categories as opposed to unique product numbers.

Described herein is a method for inferring the most efficient pick path from a set of product categories that adhere to a hierarchical structure, but which do not contain ordinal information (i.e., where the product category labels themselves are unsortable). To reduce the complexity of the space, the method uses product categories forming a hierarchical relationship, where each level becomes progressively more specific/granular, e.g., L1: Produce, L2: Vegetables, L3: Spinach, L4: Organic Spinach, and so forth.

The use of product categories introduces a precision versus coverage trade-off, where accuracy is maximized at the most granular level (e.g., L4), and data requirements scale exponentially when transitioning from broad to more precise categories. There may also be a risk of missing values (i.e., NULL values), or in some instances, actionable values that are not reliable. To address these issues, the embodiments described herein execute a distance minimization strategy on multiple levels of product categories in a hierarchical framework. The framework is extensible, but in one embodiment, level 2 (L2) and level 3 (L3) in the hierarchy may correspond to ‘department’ and ‘aisle’ product category tiers respectively. In one embodiment, a distance matrix may be generated. For a less-granular product category tier, such as departments, the distance matrix may be approximately 100×100 matrix. For a more-granular product category, such as aisles, the distance matrix may be slightly larger than a 1,000×1,000 matrix. In various embodiments, a balance can be struck between the computation requirements and accuracy.

In one embodiment, using historical data (e.g., the past 270 days' worth of orders), pairwise relations between product categories within a department product category tier and between product categories within an aisle product category tier can be calculated/generated. As one example, if an order at a particular store involved items from 5 departments and 7 aisles, then a 5×5 and a 7×7 matrix of the time differences between the initial visitations to those regions of the store can be generated. This procedure may be executed for all orders within a dataset in order to calculate the median amount of time elapsed between store regions.

Once the pairwise relations have been calculated and stored (e.g., as a 100×100 matrix for departments and 1,000×1,000 matrix for aisles), a starting point or seed may need to be established. Looking at the historical data of past orders for a store/warehouse, a proportion of time that a particular department or aisle was visited first. The department/aisle that shows the greatest propensity to be visited first can be established as the “anchor entity,” and may be the seed for the sequence building process.

Beginning with the anchor department/aisle, pairwise relations for each tier is evaluated concurrently, and the sequence is formed by moving in the direction of shortest distance. In one example, if ‘Vegetables’ is the anchor entity and the aisle with the smallest time difference is ‘Fruit,’ Vegetables' and ‘Fruit’ may then be struck from the distance matrix, before moving from ‘Fruit’ to the product category in the aisle tier of minimal distance to ‘Fruit.’ The selection process may be iteratively repeated until the distance matrices are exhausted. The result is a plurality of sequences, such as a sequence of departments and a sequence of aisles.

When an order for items offered at a warehouse (e.g., a list of products to assemble) is received, a sorted shopping list that provides an efficient route through the warehouse (i.e., pick sequence) can be generated. This may be achieved by querying the most granular of the generated sequences (e.g., aisle sequence) and pulling an associated rank for each of the corresponding locations within the store (e.g., ranking each aisle represented in the shopping list).

Because there may be insufficient historical data in cases where order volume is low, there may be some missing values for categories not represented in past orders. In one embodiment, when shopping list creation logic encounters a missing value, a corresponding value of a less granular product category may be queried to estimate the rank. The system determines if there are any other items in the received order that have valid data contained within the same broader category (e.g., department) as the item having a missing value. If so, associated ranks in the tier of the missing data for the other items is obtained, and an average is calculated. If not, then the ranks clustered within the tier of the missing data are obtained and the average of those ranks are substituted for the missing data. By jumping back and forth between different levels within the hierarchically structured product data, accuracy can be maximized while avoiding/reducing the pitfalls of scarce data.

### System Architecture

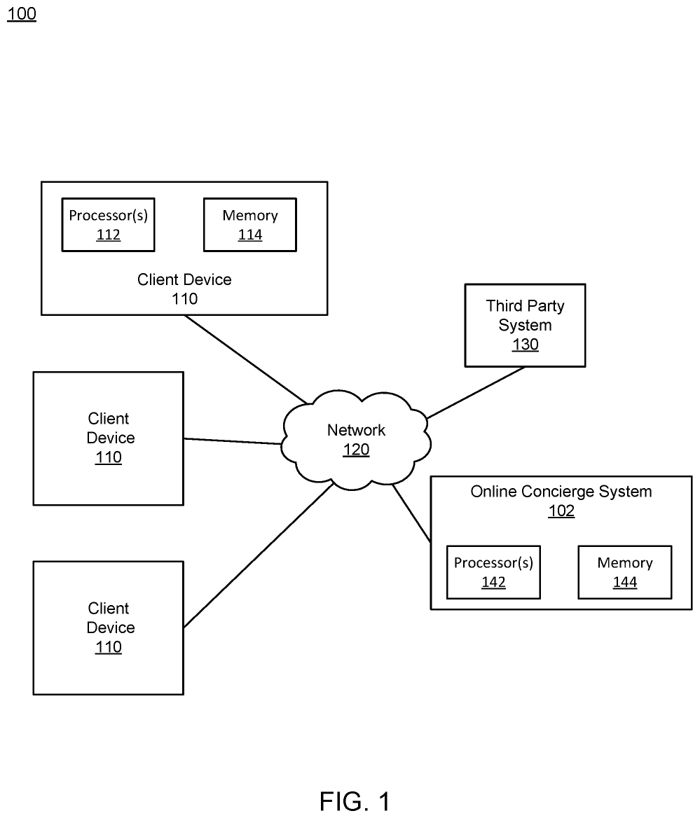

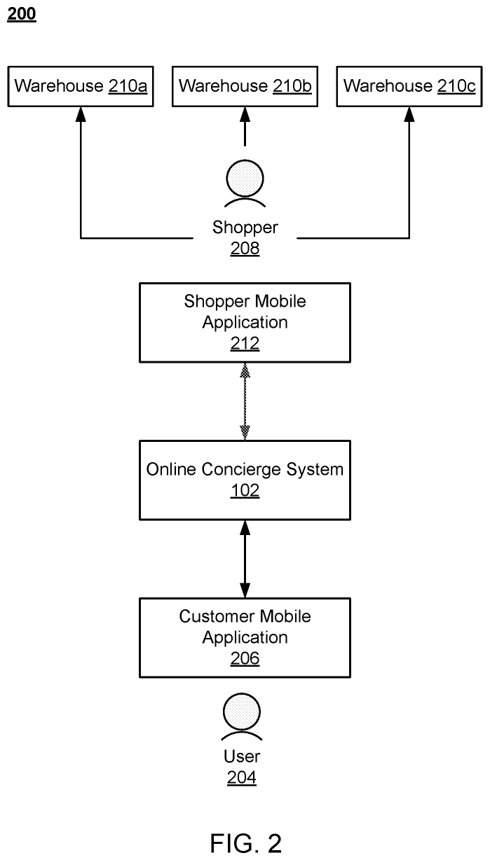

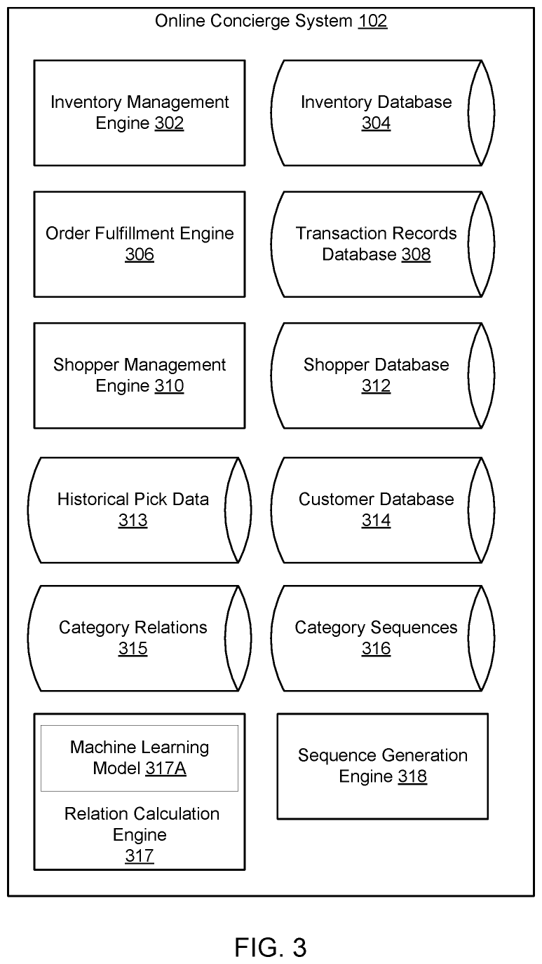

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

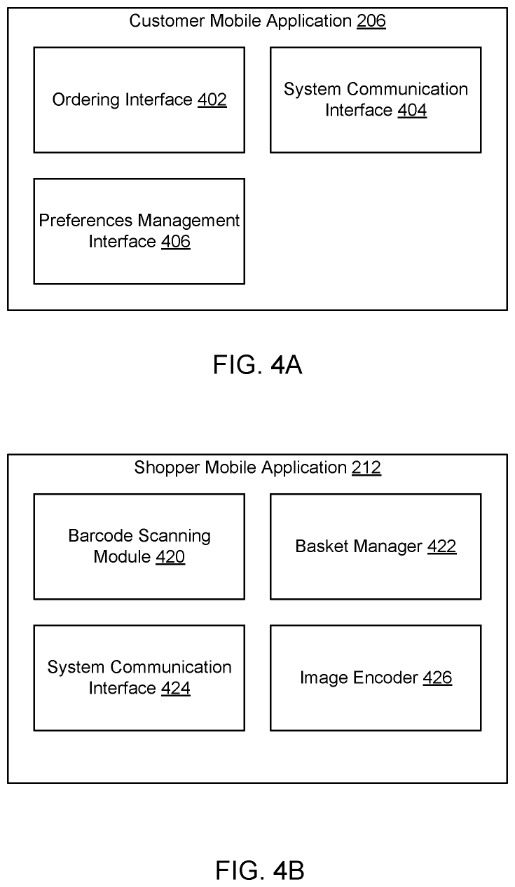

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212 (described below in conjunction with FIGS. 4A and 4B, respectively) to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described above in conjunction with FIGS. 2, 3, and 5. For example, the memory 144 has instructions encoded thereon that, when executed by the processor 142, cause the processor 142 to obtain historical pick data for items located in a warehouse, determine a taxonomy of items offered by the warehouse, generate pairwise relations between product categories at each level of the taxonomy (e.g., by applying the historical pick data to a machine learning model), generate sequences of product categories, receive an order, compare the order to at least one sequence to generate a pick sequence for the order, and output the pick sequence. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-5, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. In embodiments, the list of goods may be a list of items offered at one or more of the warehouses 210, such as products sold by a retailer and/or stored at one of the warehouses 210. The order also specifies the location to which the goods are to be delivered, and a time window during which the goods should be delivered. In some embodiments, the order specifies one or more retailers from which the selected items should be purchased. The user/customer 204 may use a customer mobile application (CMA) 206 to place the order; the CMA 206 is configured to communicate with the online concierge system 102. As described herein, a “user of a CMA” and a “customer” may be used interchangeably.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car.

The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102. In embodiments, each of the one or more warehouses 210 may have a physical layout that differs from the other warehouses 210, and which may or may not be known to the shopper 208 at the time of receiving an order. For example, in a warehouse 210a, a produce department may be located close to a meat department and far away from the frozen foods department; however, in a warehouse 210b the produce department may be located far away from the meat department and close to the frozen foods department. As another example, in the warehouse 210b the frozen vegetables aisle may be close to the vegetable aisle and far away from the frozen pizza aisle, whereas in a warehouse 210c the frozen vegetables aisle may be far away from the vegetable aisle and close to the frozen pizza aisle.

In embodiments, the shopper 208 may not have information about the location of each item in a received order. The shopper 208 may not know the most efficient route through the warehouse to fulfill the order. To recommend an efficient route to the shopper 208, embodiments provide the shopper 208 with a pick sequence for the order through the shopper mobile application 212. A “pick sequence” may refer to a recommended sequence for picking items ordered by one or more users 204, such as a ranking of each item from first to last. By picking the items in the recommended sequence, the shopper 208 is able to take an efficient route through a warehouse 210 and fulfill a received order quickly, even when the shopper 208 may not know the layout of the warehouse 210 or the location of specific items in the order. For each item in an order, product data may be identified, including product categories that the item is associated with. As used herein, a “product category” may refer to a classification of items or products having the same or similar attributes or product data. For example, each product category may relate to a group of items that share at least one physical feature, that are similarly marketed, or that come from the same or similar source. As one example, a product category may be a classification that is reflected in the organizational layout of a store or warehouse, such as “produce department,” “cereal aisle,” “men's clothing section,” “women's clothing section,” “fiction,” “non-fiction,” “self-help,” etc. For each of the warehouses 210a, 210b, and 210c, the product categories may be ranked according to predetermined sequences, as discussed in greater detail with respect to FIGS. 3-7. The predetermined sequences may be used to rank each item in the received order and generate the pick sequence.

The pick sequence may be sent to a client device storing the shopper mobile application 212. The client device performs one or more actions based on the pick sequence. The pick sequence may be communicated using text, graphics, other client device output, or some combination thereof. In one embodiment, the pick sequence may be rendered on the client device as a shopping list. For example, the shopping list may be a text or graphic showing the items of the pick sequence in ranked order. In other examples, the shopping list may be communicated through audio or displayed as a map or other graphic. The one or more actions performed based on the pick sequence may further include picking the items. For example, the shopper 208 may navigate from aisle to aisle or department to department in the recommended sequence. In embodiments where the shopper is an autonomous robot, the one or more actions may include translating the pick sequence into control signals for picking the items in sequence.

In embodiments, the online concierge system 102 may receive from the customer mobile application 206 an order for items offered by one or more of the warehouses 210. For each item in the order, the online concierge system 102 may identify product categories associated with sequences of product categories and ranks each item based on the order of its identified product categories in the least one sequence. Each of the items may be ranked based on a position of its identified product category in a most granular sequence, which may correspond to the most granular product category available (e.g., an aisle category), and if none of the identified product categories of one or more of the items are contained in the most granular sequence, a ranking for the one or more items based on a less granular sequence (e.g., a department sequence) is estimated. Then, the online concierge system 102 generates the pick sequence for the order based on the rankings and sends the pick sequence to the shopper mobile application 212 that initiates or performs an action based on the pick sequence.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304.

The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and other product data. The attributes of items may be used to determine product categories that the items are associated with. In embodiments, the product categories may have varying levels of granularity.

This inventory database 304 may further include item-warehouse pairs, such as associations between items in a delivery order and a warehouse at which the order could be fulfilled, such as one or more warehouses that offer the items for sale, delivery, or provide any other form of offering. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and use the information to determine a taxonomy of product categories for items offered by the warehouse, as explained further below.

In one embodiment, the inventory database 304 also stores purchasing rules associated with each item, if they exist. For example, age-restricted items such as alcohol and tobacco are flagged accordingly in the inventory database 304. Inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different product categories for various items. In some embodiments, the attribute values can be used to determine the product categories associated with each item in inventory database 304. For example, the product categories may each correspond to a class of items sharing a set of particular attributes or having similar attribute values. In embodiments, the product categories may be determined using inventory management engine 302.

In embodiments, the inventory management engine 302 maintains a taxonomy of items offered for purchase by one or more warehouses 210 and classifies, groups, and organizes the items into product categories. For example, the inventory management engine 302 receives an item catalog from a warehouse 210 identifying items offered for purchase by the warehouse 210, and from the item catalog, the inventory management engine 202 determines the taxonomy. The taxonomy identifies a product category and associates one or more specific items with the product category. For example, a product category identifies “milk,” and the taxonomy associates identifiers of different milk items (e.g., milk offered by different brands, milk having one or more different attributes, etc.), with the category. Thus, the taxonomy maintains associations between a product category and specific items offered by the warehouse 210 matching the product category.

In embodiments, the taxonomy is structured as a hierarchy, where different levels in the hierarchy provide different levels of specificity/granularity about items included in the levels. At each level of the hierarchy, items can be grouped into product categories corresponding to product data of varying levels of granularity. For example, at the top of the hierarchy, level 1 (L1), may be a broad categorization about the items (e.g., food, home goods, shoes, electronics, etc.), which may correspond to a very large area within an area, or even the warehouse as a whole (e.g., warehouse is a store that does not offer a diverse set of products). Each level below in the hierarchy becomes more and more granular. Conversely, at the bottom level of the taxonomy may be a product category of greatest specificity, such as level 3 (L3) granularity, which may include product categories corresponding to specific aisles in a warehouse (e.g., vegetables, fruit, fresh fish, crab, frozen pizza, frozen vegetables, etc.). And one level above the bottom level may be product data of level 2 (L2) granularity, which may correspond to specific departments in a warehouse (e.g., produce, meat, seafood, frozen, etc.). In some embodiments, a taxonomy can include additional levels below L3 having more granular product data. For example, level 4 (L4) granularity may include product categories corresponding to a particular section of an aisle or horizontal placement within an aisle (e.g., apples, milk, milk substitutes), and level 5 (L5) granularity may include product categories corresponding to a particular subsection of an aisle, particular shelf, or vertical placement within a section of an aisle (e.g., organic apples, red apples, green apples, whole milk, skim milk, oat milk, soy milk, etc.).

In embodiments, different levels in the taxonomy can identify items with differing levels of specificity/granularity based on any suitable attribute or combination of attributes of the items. For example, different levels of the taxonomy specify different combinations of attributes for items, so items in lower levels of the taxonomy may have a greater number of attributes, corresponding to greater specificity in a category, while items in higher levels of the taxonomy have a fewer number of attributes, corresponding to less specificity in a product category. In various embodiments, higher levels in the taxonomy may include less detail about items, so greater numbers of items may be included in higher levels (e.g., higher levels include a greater number of items satisfying a broader, less granular category). Similarly, lower levels in the taxonomy include greater detail about items, so fewer numbers of items are included in the lower levels (e.g., lower levels include a fewer number of items satisfying a more specific, more granular category).

The inventory management engine 302 determines taxonomies for one or more warehouses 210. Determining each taxonomy may include receiving the taxonomy from the warehouse 210 in various embodiments. In other embodiments, the inventory management engine 302 may apply a trained classification module to an item catalog received from the warehouse 210, such that application of the trained classification model associates specific items with product categories corresponding to levels within the taxonomy. In other embodiments, the inventory management engine 302 may determine the taxonomy by selecting one or more taxonomies that may apply to different types of warehouses 210. For example, a taxonomy for a grocery store may differ from a taxonomy for a home goods store, and the inventory management engine 302 may select the appropriate taxonomy depending on the type of store and the types of products/items it offers.

The online concierge system 102 also includes an order fulfillment engine 306 which is configured to synthesize and display an ordering interface to each user 204 (for example, via the customer mobile application 206). Each user 204 uses the ordering interface to place an order for items offered at a warehouse 210. The order is received by the online concierge system 102 for further processing.

As part of fulfilling an order, the order fulfillment engine 306 and/or shopper management engine 310 may access a customer database 314 which stores information describing each user. This information could include each user's name, address, gender, shopping preferences, favorite items, stored payment instruments, and so on.

The order fulfillment engine 306 is also configured to access the inventory database 304 in order to determine which products are available at which warehouse 210. The order fulfillment engine 306 may supplement the product availability information from the inventory database 234. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device 110 of a user 204 for display via the customer mobile application. The order fulfillment engine 306 receives a query comprising one or more terms from the user 204 and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with, and utilization of, shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. In embodiments, the shopper management engine 310 may provide the contents of an order to the one or more shoppers 208 as, or in relation to, a pick sequence for the order. For example, the shopper management engine 310 recommends an efficient order/sequence that a shopper 208 should pick the constituent items of a customer's order.

Additionally, the shopper management engine 310 accesses a shopper database 312 which stores information describing each shopper 208, such as his/her name, gender, rating, previous shopping history, and so on. In embodiments, the previous shopping history may include information about warehouses where the shopper 208 has fulfilled orders, as well as time data corresponding to the fulfilled orders. The time data may include timestamps for each item picked by the shopper 208 when fulfilling the orders at the warehouses, which may be used to calculate pick times between each item picked, and thereby indicating the time it took the shopper 208 to go from picking one item in an order to the next. In some embodiments, the time data may be used to supplement historical pick data 313. For example, pick times for each shopper may be used as a statistical weight or normalization factor when calculating relations between product categories at a warehouse (e.g., category relations 315) and inferring the relative distances between product categories at the warehouse. In embodiments, shopper management engine 310 recommends a pick sequence to the shopper 208 for fulfilling the order in a manner that is most efficient for the warehouse (i.e., provides the quickest route for picking items in a received order).

In various embodiments, the order fulfillment engine 306 may determine whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212. In embodiments, each of the one or more batches may be a set of received orders at the same warehouse 210. The entire set of orders in a batch may be assigned to a shopper 208, so that the shopper 208 can pick the items from the warehouse 210 during a single trip. In embodiments, a pick sequence for the batch may be generated using the methods described herein for determining a pick sequence for a received order, where the items in a batch may be treated as items in a single order. This may enable the shopper 208 to take an efficient route through the warehouse 210 when simultaneously fulfilling the orders contained in the batch.

The online concierge system 102 further includes category historical pick data 313, a customer database 314, category relations 315, category sequences 316, a relation calculation engine 317, and a sequence generation engine 318. Historical pick data 313 includes data collected from past fulfilled orders. Historical pick data 313 for each warehouse 210 may include product data for each of the items picked at the warehouse 210 and pick times between each of the items picked. In one embodiment, the historical pick data 313 may be stored in the same location as records of inventory database 304. In some embodiments, historical pick data 313 may be generated by aggregating or retrieving data from inventory database 304, shopper database 312, customer database 314, other databases, or some combination thereof.

The historical pick data 313 relates a variety of different factors to known item availabilities from the outcomes of previous delivery orders (e.g., if an item was previously found or previously unavailable). The historical pick data 313 include the items included in previous delivery orders, whether the items in the previous delivery orders were picked, warehouses associated with the previous delivery orders, and a variety of product data associated with each of the items (which may be obtained from the inventory database 304). The historical pick data 313 may also include the outcome of a previous delivery order (e.g., if the item was picked or not).

The historical pick data 313 includes a time associated with previous delivery orders. In some embodiments, the historical pick data 313 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the historical pick data 313 include a day of the week previous delivery orders were placed. The day of the week may impact item availability since popular shopping days may have reduced inventory of items or restocking shipments may be received on particular days.

In embodiments, historical pick data 313 may include a time interval since an item was previously picked in a previously delivered order. If an item has recently been picked at a warehouse, this may increase the probability that it is still available. If there has been a long time interval since an item has been picked, this may indicate that the probability that it is available for subsequent orders is low or uncertain. In some embodiments, historical pick data 313 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, historical pick data 313 may also include a rate at which an item is typically found by a shopper at a warehouse, a number of days since inventory information about the item was last received from the inventory management engine 302, a number of times an item was not found in a previous week, or any number of additional rate or time information.

The historical pick data 313 also includes product data for the items picked in previous orders at a warehouse 210, such as item characteristics pertaining to product categories of items offered by the warehouse 210. In some examples, the item characteristics include a department associated with the item. For example, if the item is yogurt, it may be associated with the dairy department, which may be a level 2 product category. Other non-limiting examples of departments may include the bakery, beverage, nonfood, and pharmacy, produce and floral, deli, prepared foods, meat, seafood, dairy, the meat department, or dairy department, or other categorization of items of similar granularity used by a warehouse 210. In some examples, the item characteristics may also include an aisle of the warehouse associated with the item, which may include more granular item characteristics than that of departments.

Additionally, in some embodiments, the item characteristics may include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may further include a number of times a shopper was instructed to keep looking for the item after he or she was initially unable to find the item, a total number of delivery orders received for the item, whether or not the product is organic, vegan, gluten free, or any other characteristics associated with an item.

Inventory information provided by the inventory management engine 302 may supplement the historical pick data 313. Inventory information provided by the inventory management engine 302 may not necessarily include information about the outcome of picking a delivery order associated with the item, whereas the data within the historical pick data 313 may be structured to include an outcome of picking a delivery order (e.g., if the item in an order was picked or not picked). In embodiments, the online concierge system 102 may use historical pick data 313 to calculate category relations 315 for generating category sequences 316, such as by applying the historical pick data 313 to a machine learning model 317A as input to obtain the category relations 315 as output. The category relations 315 for a warehouse 210 may primarily be determined based on product data for each of the items picked and pick times between each of the items picked for past orders of the warehouse 210; however, in various embodiments, any one piece of data from historical pick data 313, inventory database 304, transaction records database 308, shopper database 312, and/or customer database 314 may be used as a factor (e.g., weighting or normalization factor) when calculating or determining the category relations 315.

Category relations 315 include pairwise relations between product categories. The pairwise relations may include distance values. As used herein, a “distance value” may refer to a quantitative measure of the strength of relationship between two pieces of data. For example, the distance value may be a normalized value representing how closely related two product categories at a warehouse 210 are, and thus, providing an estimate that can be used to infer the relative locations of items associated with the product categories at the warehouse 210, without informed knowledge about its physical layout (e.g., lack of ordinal data). The category relations 315 may include pairwise relations between product categories within each hierarchical level of the taxonomy. For example, the category relations 315 may include distance values between each aisle product category in the aisle level of the taxonomy, and distance values between each department product category in the department level of the taxonomy. In embodiments, the category relations 315 are calculated based on a statistical measure pertaining to the pick times between product categories as recorded in historical pick data 313.

Relation calculation engine 317 uses historical pick data 313 to calculate the category relations 315. In embodiments, relation calculation engine 317 calculates category relations 315 between product categories at each level in a warehouse's taxonomy. Using historical pick data 313 for a warehouse 210, relation calculation engine 317 determines a statistical measure pertaining to the pick times between product categories within the same hierarchical level (i.e., having the same particular level of granularity). For example, the statistical measure may include a median time, average time, weighted average time, statistical-based prediction (e.g., using machine learning via machine learning model 317A), probabilistic time estimate, other statistically or probabilistically determined time estimate or measure of central tendency, or some combination thereof. In other examples, the statistical measure may be a minimum pick time, maximum pick time, or some other measurable value derived from the historical pick data 313. In one embodiment, the statistical measure may be a value determined heuristically. In one embodiment, the statistical measure may involve excluding outliers. The statistical measure is used to calculate a normalized value, such as a distance value, relating to the relationship between each product category at each level of the taxonomy to calculate the category relations 315. In embodiments, the statistical measure involves weighting the distance value based on data stored in inventory database 304, transaction records database 308, shopper database 312, customer database 314, or some combination thereof. For example, to account for shoppers that may be faster or more experienced than others, especially with respect to particular warehouses they have fulfilled a large quantity of orders at, shopper data from shopper database 312 may be used to normalize the historical pick data 313 when calculating category relations 315. Conversely, if shopper data from shopper database 312 indicates that a shopper is a novice shopper, the shopper data may be used to normalize the historical pick data 313 to account for the shopper's slower pick rate.

Relation calculation engine 317 comprises machine learning model 317A. Relation calculation engine 317 may generate the pairwise relations by applying the historical pick data to the machine learning model 317A. The machine learning model 317A may be trained to predict the pairwise relations between product categories based on historical pick times between items relating to the product categories, in addition to other data in the historical pick data 313, data from inventory database 304, data from transaction records database 308, data from shopper database 312, data from customer database 314, other data provided to the online concierge system 102, or some combination thereof. For example, historical pick data, shopper data, customer data, and target pairwise relations may be provided as training data, and the machine learning model 317A may learn to predict pairwise relations between product categories by weighing the historical pick times for items relating to the product categories, attributes of a shopper, and attributes of a customer, and through training, the weights may be updated to reduce an error or cost between predicted pairwise relations and the target pairwise relations. The updated weights may be used to form the trained machine learning model 317A. In one embodiment, the machine learning model 317A may be a linear model trained to infer weights for an individual observation from the historical pick data. For example, if a shopper texts a customer between items, the time difference between picks may not be reflective of the time of travel between product categories, and thus, may be down weighted.

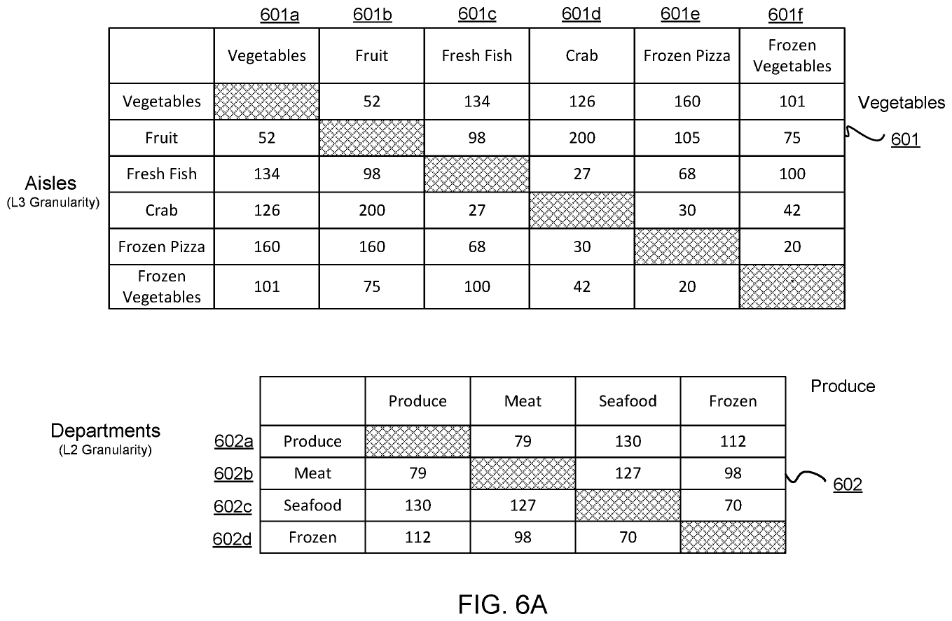

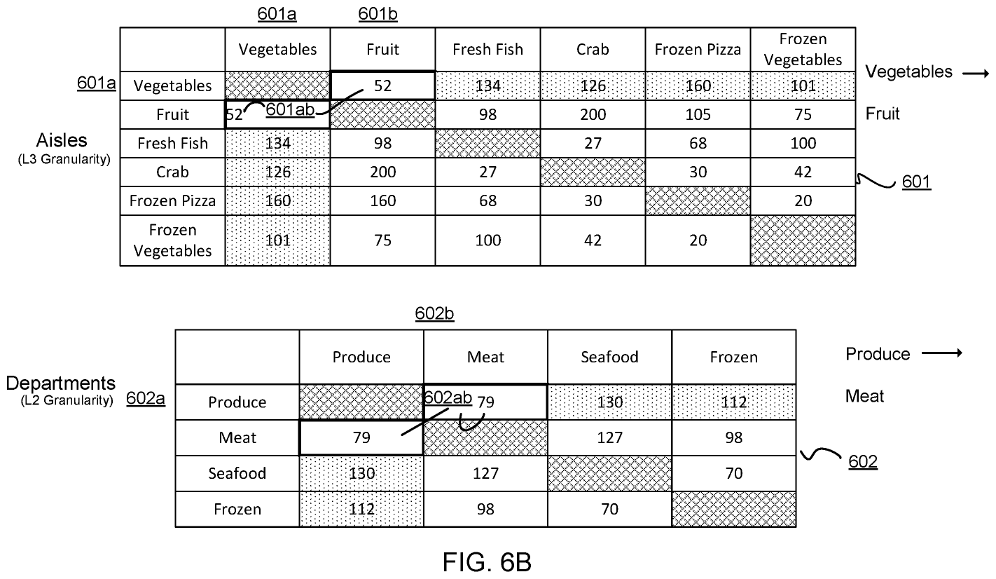

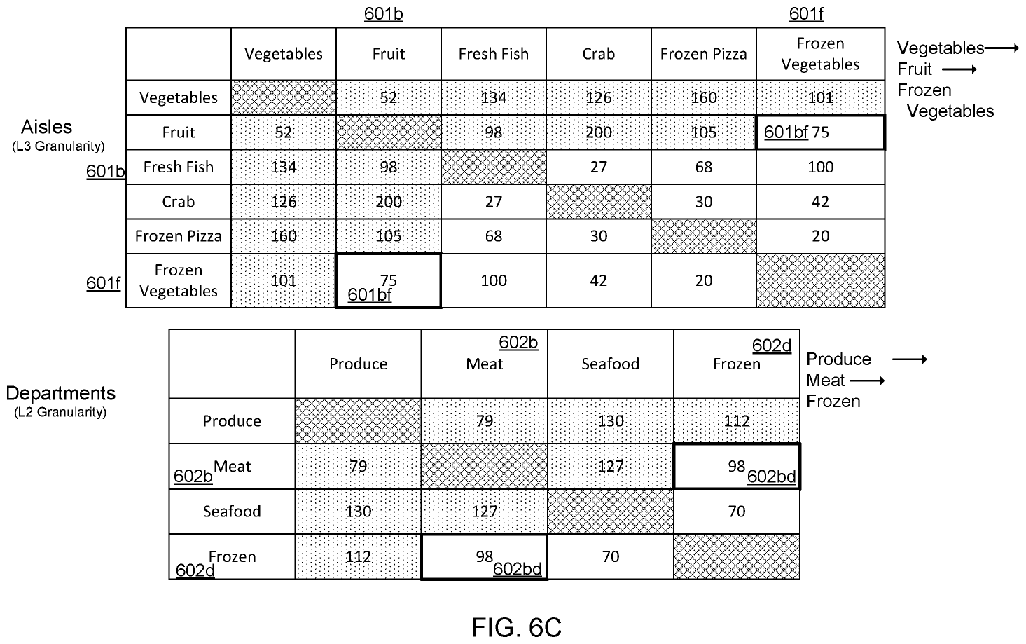

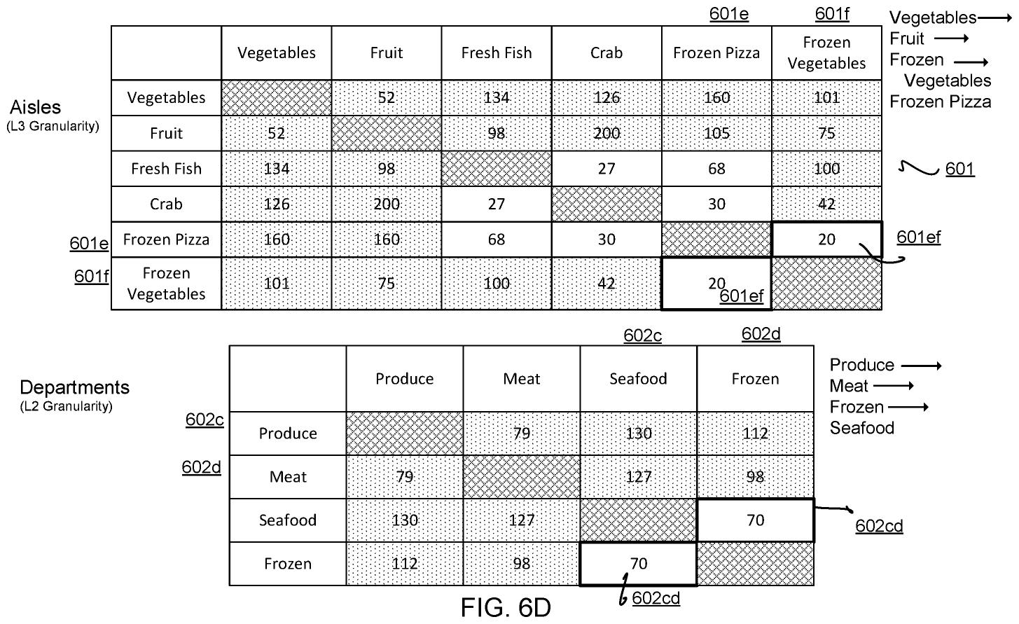

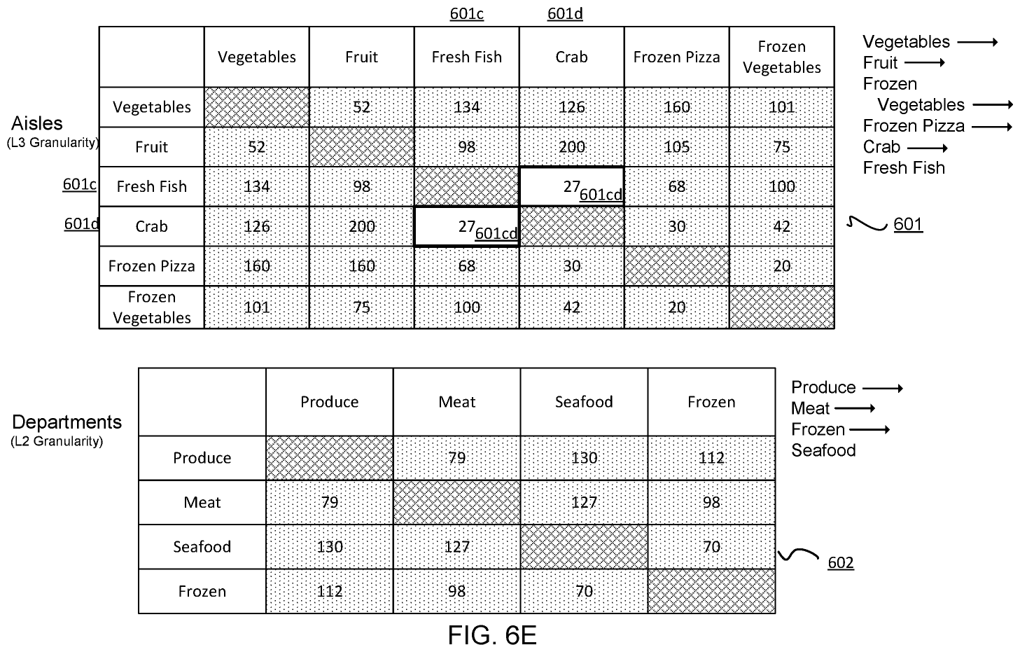

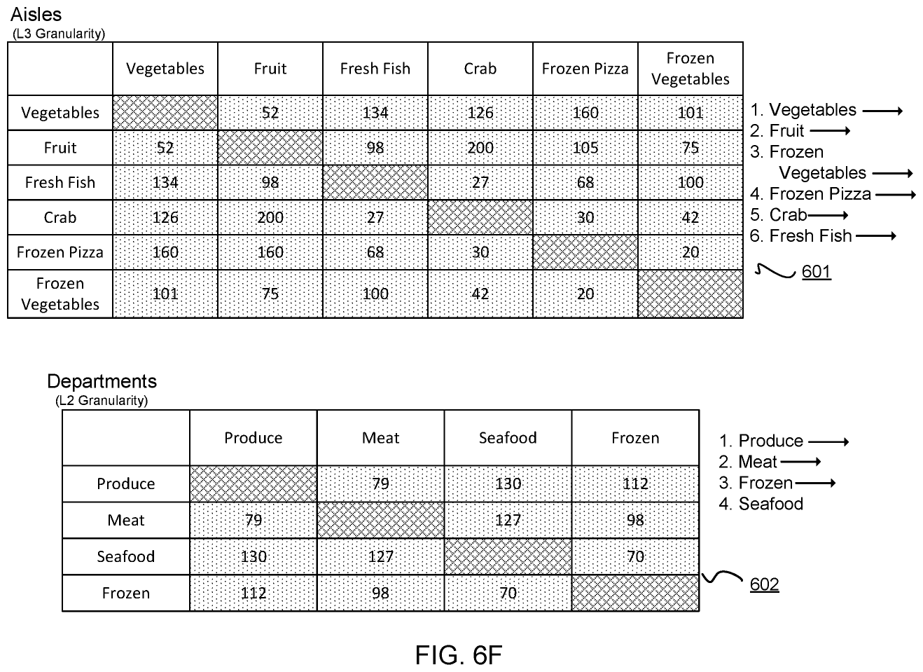

In one embodiment, relation calculation engine 317 may calculate a median pick time between items of a first product category in a particular level to all of the other product categories in the particular levels. For example, a first product category may be a “vegetable” product category pertaining to L3 granularity, “aisles,” and relation calculation engine 317 may calculate the median pick times between items associated with “vegetable” and items associated with “fruit,” and may additionally calculate median pick times between vegetable items and items associated with “fresh fish,” and items associated with the other 98 product categories at the aisle level. Relation calculation engine 317 may store the category relations 315 as a distance matrix. The distance matrix may be symmetrical. The 99 pairwise relations can then be stored in a 100×100 L3 granularity matrix. Further details regarding matrices of pairwise relations are discussed below with respect to the description of FIGS. 6A-6F.

The category sequences 316 comprise sequences of product data associated with items offered by a warehouse. The category sequences 316 can be used to derive a ranking for items listed in a received order that a shopper 208 is tasked with fulfilling. The category sequences 316 may be used to determine instructions delivered to the shopper 208 (e.g., pick sequence), as described in greater detail further below. In embodiments, the category sequences 316 may comprise a ranking of product categories at each level of granularity in a taxonomy. For example, the category sequences 316 for a warehouse 210 may include an L1 sequence for the warehouse 210, an L2 sequence for the warehouse 210, an L3 sequence for the warehouse 210. Each of the sequences provides a ranking of product categories from which relative locations of items belonging to the product categories can be inferred, such as their proximity of items in one product category to items in another product category in the warehouse 210.

Sequence generation engine 318 generates sequences, including category sequences 316. In embodiments, sequence generation engine 318 may generate category sequences 316 for each level of granularity in a taxonomy for a warehouse. Sequence generation engine 318 selects a particular level for which a sequence is to be generated and selects a seed amongst the product categories in the particular level. The “seed” may refer to an initial value or reference point in a process for building a sequence. For example, the seed may be a product category that establishes the first product category in a category sequence and that serves as a reference point from which to determine the next product category in the category sequence. In embodiments, the seed may be a product category that is most associated with an initial pick for the given warehouse. For example, the product category may be associated with a department or aisle that is close to the warehouse entrance or close to where shoppers 208 are typically deployed. In embodiments, the product category most associated with an initial pick for the warehouse may be determined based on historical pick data 313. For example, based on past orders fulfilled at a given warehouse, sequence generation engine 318 may determine a product category that is most commonly picked first amongst the other product categories in the same level of the taxonomy.

Upon selecting the seed, to determine the next product category in the sequence, sequence generation engine 318 determines a shortest distance product category from the seed based on the relevant pairwise relations. The shortest distance product category is determined using category relations 315. For example, the shortest distance product category is the product category that has the strongest relation to the product category that is currently selected in the sequence building process (i.e., lowest distance value). The shortest distance product category is then selected as the next product category in the sequence (i.e., the currently selected product category), and to determine the product category that follows after, the shortest distance product category from that product category is evaluated in the same manner. The process of selecting the shortest product category from the currently selected product category as the next product category in the sequence continues until all product categories in the particular level of the taxonomy have been selected. The final sequence at the end of the process is stored in category sequences 316. In embodiments, the sequence building process is repeated for each level of the taxonomy's hierarchy. Upon building a first category sequence for a warehouse, the sequence generation engine 318 may select another level in the hierarchy, determine a seed, and repeat the process of iterating through shortest distance product categories to build the next category sequence for the warehouse.

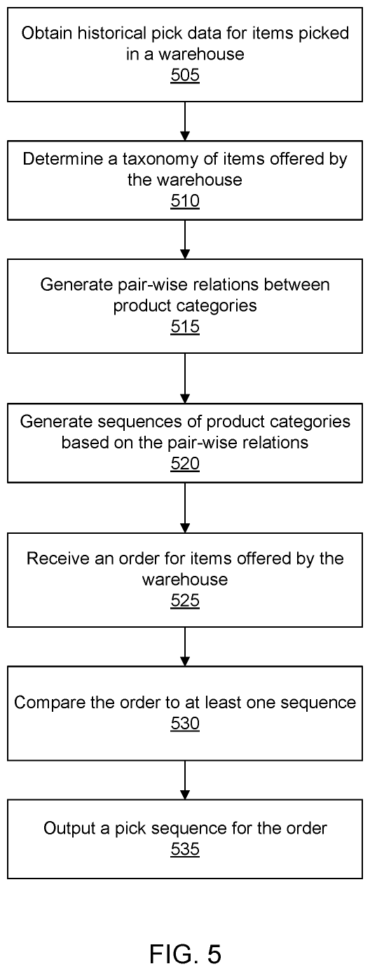

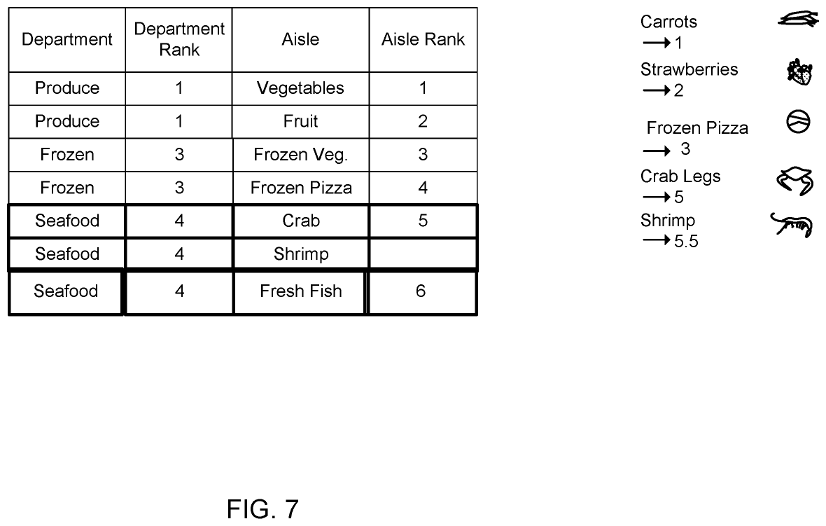

In embodiments, sequence generation engine 318 may further generate pick sequences for orders received through order fulfillment engine 306. The pick sequence may be provided to a shopper 208 via shopper management engine 310. Orders received through order fulfillment engine 306 may be compared to one or more category sequences 316 to generate the pick sequences for the orders. When an order for items offered at a warehouse is received, the most granular sequence for the warehouse may be queried from category sequences 316. For each item in the order, sequence generation engine 318 identifies product categories associated with the sequence and ranks each item based on a position of its identified product categories in the queried sequence. For example, if an item has a product category that is listed first in the queried sequence, it will be ranked as first. Items having product categories earlier in the queried sequence will be ranked higher than those having a product category listed later in the queried sequence. The sequence generation engine 318 then generates the pick sequence for the order based on the ranking. If none of the identified product categories of an item are contained in the queried sequence, sequence generation engine 318 estimates a ranking for the item based on the sequence generated one level above the queried sequence (e.g., refers to level 2 if the level 3 sequence contains a null value). Additional details regarding pick sequence generation are provided with respect to the description of FIGS. 5 and 7 further below.

### Customer Mobile Application

FIG. 4A is a diagram of the customer mobile application (CMA) 206, according to one or more embodiments. The CMA 206 includes an ordering interface 402, which provides an interactive interface with which the user 104 can browse through and select products and place an order. The CMA 206 also includes a system communication interface 404 which, among other functions, receives inventory information from the online concierge system 102 and transmits order information to the system 202. The CMA 206 also includes a preferences management interface 406 which allows the user 104 to manage basic information associated with his/her account, such as his/her home address and payment instruments. The preferences management interface 406 may also allow the user to manage other details such as his/her favorite or preferred warehouses 210, preferred delivery times, special instructions for delivery, and so on. In embodiments, the CMA 206 is configured to receive selections for items offered by a warehouse, generate an order containing the items, and send the order to an online concierge system 102.

### Shopper Mobile Application

FIG. 4B is a diagram of the shopper mobile application (SMA) 212, according to one or more embodiments. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 208 to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out. In embodiments, the SMA 212 receives a pick sequence, and based on the pick sequence, initiates or performs one or more actions. For example, the SMA 212 may render the pick sequence as a shopping list or may generate control signals for executing the pick sequence to fulfill an order at a warehouse.

### Determining Efficient Sequences for Picking Ordered Items

FIG. 5 is a flowchart of one embodiment of a method for method for determining efficient sequences for picking ordered items. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by a system, which may be the online concierge system 102 in various embodiments, while in other embodiments, the steps of the method are performed by any online system capable of retrieving items.

The system obtains 505 historical pick data for items located in a warehouse. For example, a history of past orders fulfilled at a warehouse over a predetermined period of time (e.g., the last 3 months, the last 6 months, the last 9 months, the last 270 days, over the past year, etc.) is retrieved from a database where information for orders fulfilled at the warehouse are stored. The historical pick data comprises product data for each of the items picked and pick times between of the items picked. For example, each item in an order may be associated with attributes that relate to product categories that the picked items belong to. Additionally, the previously fulfilled orders include timestamps indicating when each item is picked, which can be used to determine time durations between picking one type of item and another type of item. For example, the historical pick data may include a set of time durations indicating the time it has taken shoppers to pick a vegetable after picking a fruit, a set of time durations indicating the time it has taken shoppers to pick a fruit after picking milk, a set of time durations indicating the time it has taken shoppers to pick ice cream after picking frozen pizza, and so on.

The system determines 510 a taxonomy of items offered by the warehouse. The taxonomy identifies a plurality of product categories structured in a hierarchy. Each level of the hierarchy corresponds to a particular level of granularity of product data. For example, the most granular level in the hierarchy may be an aisle level, where product categories pertaining to typical aisles at a grocery store are included, such as vegetables, fruit, frozen vegetables, frozen pizza, crab, shrimp, fresh fish, and so on. One level above in the hierarchy may be a department level, which may include less granular product categories that pertain to typical departments at a grocery store, such as produce, frozen, and seafood.

The system generates 515 pairwise relations between product categories. The pairwise relations are generated for the product categories at each level of the taxonomy using the historical pick data. For example, a set of pairwise relations are determined for each pair of aisle product categories in the aisle level and another set of pairwise relations are determined for each pair of department product categories in the department level. The pairwise relations are generated using the historical pick times between each product category. Shorter pick times between two product categories indicate a stronger relation (i.e., lower/shorter distance value). In one embodiment, the system generates the pairwise relations by applying the historical pick data to a machine learning model. The machine learning model may be trained to predict the pairwise relations between product categories based on historical pick times between items relating to the product categories, in addition to other data in the historical pick data, data from inventory database 304, data from transaction records database 308, data from shopper database 312, data from customer database 314, other data provided to the online concierge system 102, or some combination thereof. For example, historical pick data, shopper data, customer data, and target pairwise relations may be provided as training data, and the machine learning model may learn to predict pairwise relations between product categories by weighing the historical pick times for items relating to the product categories, attributes of a shopper, and attributes of a customer, and through training, the weights may be updated to reduce an error or cost between predicted pairwise relations and the target pairwise relations. The updated weights may be used to form the trained model. In one embodiment, the machine learning model may be a linear model trained to infer weights for an individual observation from the historical pick data. For example, if a shopper texts a customer between items, the time difference between picks may not be truly reflective of the time of travel between product categories, and thus, should be down weighted.

The system generates 520 sequences of product categories based on the pairwise relation calculated at step 515. A sequence is generated for each level in the hierarchy. The system selects a particular level in the hierarchy to begin building a sequence and selects a product category most associated with an initial pick at the warehouse as the seed for building the rest of the sequence. The system builds the sequence by traversing the pairwise relations in order of strongest relation to the currently selected product category. For example, if the seed is a vegetables product category, the system next selects the product category having the shortest distance pairwise relation to vegetables, which may be fruit. From fruit, the product category having the shortest distance pairwise relation may be fresh fish. The system continues in this manner until all product categories in the aisle level have been selected and included in the sequence. The same process is performed to build the department sequence (e.g., starting from produce, traverse to the shortest distance department, which may be meat, and from meat traverse to the shortest distance department, which may be frozen).

The system receives 525 an order for items offered by the warehouse. A user of the system selects items offered by the warehouse and submits the selected items in an order. The order is received by the system, and the system begins the process of generating a pick sequence for the order, as well as any other orders that an assigned shopper is tasked with fulfilling.

The system compares 530 the order to at least one sequence in a plurality of sequences generated by the system at step 520. For each item in the order, the system identifies product categories associated with the compared sequence and ranks each item based on the position of its identified product categories in the compared sequence. For example, if an item is a vegetable, and vegetables are the first product category in the aisle sequence for the warehouse, then the vegetable item may be ranked first. If the item is a fruit, and fruit is the next product category in the aisle sequence, then the fruit item may be ranked second. The pick sequence for the order is generated based on the ranking (i.e., higher ranked items are placed in the pick sequence before the lower ranked items). For example, if vegetables are ranked first, then vegetable items are listed first in the pick sequence, thereby instructing the shopper to pick the vegetable items first. The first sequence that is compared to the items in the order may be the most granular sequence of the plurality of sequences generated for the warehouse. The sequences for the warehouse may further include the sequence generated one level above the most granular sequence. In an embodiment, ranking each item comprises determining the position of its identified product category in the most granular sequence (e.g., aisle sequence). If none of the identified product categories of an item are contained in the most granular sequence, the system estimates a ranking for the item based on the sequence generated one level above the most granular sequence (e.g., department sequence). For example, the ranking of an item with missing data in the aisle sequence may be estimated to be the average aisle ranking for items in its same department sequence. Further details regarding estimating a ranking based on a less granular sequence is provided with respect to the description of FIG. 7.

The system outputs 535 a pick sequence for the order. For example, in outputting the pick sequence for the order, the system may send the pick sequence to a shopper mobile device linked to the shopper assigned to fulfill the order, which may cause the shopper mobile device to display one or more graphical user interfaces that include the pick sequence, information associated with the pick sequence, or some combination thereof. The shopper then picks the items in the order according to the pick sequence, or performs one or more other actions in response to the pick sequence that is output by the system and received by the shopper mobile application, as previously described with respect to the description of FIG. 4B.

FIG. 6A is an illustration of pairwise relations between product categories, according to one or more embodiments. In the embodiment, pairwise relations calculated at level 3 (L3) granularity are stored in a first matrix 601. Similarly, pairwise relations calculated at level 2 (L2) granularity are stored in a second matrix 602. In the embodiment, the L3 granularity comprises product categories for aisle types and the L2 granularity comprises product categories for department types. As shown, the aisle types include vegetables 601a, fruit 601b, fresh fish 601c, crab 601d, frozen pizza 601e, and frozen vegetables 601f, and the first matrix is a 6×6 matrix, while the department types include produce 602a, meat 602b, seafood 602c, and frozen 602d, and the second matrix is 4×4 matrix. It is noted that the number of product categories, and thus the size of each matrix, is typically larger than as illustrated in FIGS. 6A-6F, and the size is reduced for the purposes of simplifying the explanation of embodiments. For example, a taxonomy may include approximately 1000 product categories in its most granular level (e.g., L3) and may include approximately 100 product categories in the level above (e.g., L2), thereby resulting in a 1000×1000 and 100×100 matrix respectively.

FIG. 6B is an illustration of selecting a first product category in a sequence, according to one or more embodiments. As shown, vegetables 601a and produce 602a are selected as the seed for the aisle sequence and department sequence respectively. From vegetables 601a, the shortest distance value 601ab is selected (e.g., ‘52’), which corresponds to the pairwise relation between vegetables 601a and fruit 601b. As such, fruit 601b is selected as the next product category in the aisle sequence. From produce 602a, the shortest distance value 602ab is selected (e.g., ‘79’), which corresponds to the pairwise relation between produce 602a and meat 602b. As such, meat 602b is selected as the next product category in the department sequence.

FIG. 6C is an illustration of generating a sequence, according to one or more embodiments. Continuing to build the aisle sequence, fruit 601b is currently selected, and the shortest distance value is 601bf, which corresponds to the pairwise relation between fruit 601b and frozen vegetables 601f. As such, frozen vegetables 601f is selected as the next product category in the aisle sequence. Continuing to build the department sequence, meat 602b is currently selected, and the shortest distance value is 602bd, which corresponds to the pairwise relation between meat 602b and frozen 602d. As such, frozen 602d is selected as the next product category in the department sequence.

FIG. 6D is an illustration of generating a sequence, according to one or more embodiments. The sequence building process continues for the aisle sequence and the department sequence. As shown, frozen vegetables 601f is currently selected for the aisle sequence, and the shortest distance value is 601ef, which corresponds to the pairwise relation between frozen vegetables 601f and frozen pizza 601e. As such, frozen pizza 601e is selected as the next product category in the aisle sequence. Frozen 602d is currently selected for the department sequence, and the shortest distance value is 602cd, which corresponds to the pairwise relation between frozen 602d and seafood 602c. As such, seafood 602c is selected as the next product category in the department sequence.

FIG. 6E is an illustration of generating a sequence, according to one or more embodiments. As shown, the second matrix 602 has been exhausted, and all of the department product categories have been selected and placed into the department sequence (1. Produce; 2. Meat; 3. Frozen; 4. Seafood). The sequence building process continues for the aisle sequence. As shown, crab 601d is currently selected and the shortest distance value is 601cd, which corresponds to the pairwise relation between crab 601d and fresh fish 601c. As such, fresh fish 601c is selected as the next product category in the aisle sequence.

FIG. 6F is an illustration of generating a sequence, according to one or more embodiments. As shown, both the first matrix 601 and second matrix 602 have been exhausted, as all product categories have been selected and placed into their corresponding sequence.

FIG. 7 is an illustration of estimating a ranking, according to one or more embodiments. An aisle product category, shrimp, contains a missing value 701b in the aisle sequence. Shrimp has a department product category of seafood and has a value 702b in the department sequence. Aisle product categories crab and fresh fish similarly are in the seafood department, and as such, have the same value 702a and 702c in the department sequence. The value in the aisle sequence for crab and fresh fish are 701a and 701c. To determine an estimate for the missing value 701b, an average of value 701a and 701c is taken. In various embodiments, a missing value in a more granular sequence can be estimated based on any heuristic using information from a less granular sequence. For example, a missing value for an aisle sequence can be estimated by assessing values of other aisle product categories having the same or closely related department value.

Embodiments described herein provide a number of technical advantages. Namely, by using historical pick data to generate pairwise relations between product categories at each level of a taxonomy structured as a hierarchy, sequences of product categories can be generated at particular levels of granularity. Pairwise relations may be generated intelligently from historical pick data and other data retrieved from disparate databases and/or extracted from devices distributed in a network connected to an online concierge system, by applying the data as input to a machine learning model trained to make inferences from the data and predict the pairwise relations. By comparing items in an order to the ranking of its product categories at the varying levels of granularity, an optimal balance between accuracy and the required number of computations can be achieved, even in a scenario where there may be sparse historical data. Therefore, efficient routes for picking items in a warehouse can be generated without requiring an unreasonable number of computational resources or an extensive amount of memory and data.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
at a computer system comprising at least one processor and non-transitory memory:
obtaining historical pick data for a plurality of items located in a warehouse, the historical pick data comprising product data for each of the items picked and pick times between each of the items picked;
determining a taxonomy of the plurality of items offered by the warehouse, the taxonomy identifying a plurality of product categories structured in a hierarchy, wherein each level of the hierarchy corresponds to a particular level of granularity of product data;
applying the historical pick data to a machine learning model to generate pairwise relations between product categories in the plurality of product categories at each level of the taxonomy;
generating a plurality of sequences of product categories based on the pairwise relations;
receiving an order for items offered by the warehouse;
comparing the order to at least one sequence in the plurality of sequences to generate a pick sequence for the order; and
outputting the pick sequence.

2. The method of claim 1, wherein comparing the order to the at least one sequence comprises:
for each item in the order, identifying one or more product categories associated with the at least one sequence;
ranking each item based on a position of the identified one or more product categories of the item in the at least one sequence; and
generating the pick sequence for the order based on the ranking.

3. The method of claim 1, wherein the at least one sequence comprises a most granular sequence in the plurality of sequences.

4. The method of claim 3, wherein the at least one sequence further comprises a sequence generated one level above the most granular sequence in the hierarchy.

5. The method of claim 4, wherein ranking each item comprises:
ranking each item based on a position of an identified product category of the item in the most granular sequence; and
based on determining that none of the identified product categories of the particular item are contained in the most granular sequence, estimating a ranking for the particular item based on the sequence generated one level above the most granular sequence.

6. The method of claim 4, wherein the most granular sequence comprises an aisle sequence, and wherein the sequence generated one level above in the hierarchy comprises a department sequence.

7. The method of claim 1, wherein each of the pairwise relations comprises a distance value.

8. The method of claim 7, wherein the distance value is calculated based on or more of: a median pick time or a weighted average pick time.

9. The method of claim 7, wherein generating the plurality of sequences comprises:
a) selecting a particular level in the hierarchy;
b) selecting a seed from the particular level as a currently selected product category, the seed establishing a first product category in a generated sequence;
c) determining, based on the calculated pairwise relations, a shortest distance product category from the currently selected product category;
d) selecting the shortest distance product category as the currently selected product category, the currently selected product category establishing a next product category in the generated sequence; and
e) repeating steps c and d until all product categories in the particular level have been selected.

10. The method of claim 9, wherein the seed is a product category most associated with an initial pick for the warehouse.

11. The method of claim 9, further comprising:
selecting another level in the hierarchy as the particular level; and
repeating steps b through e to generate an additional sequence in the plurality of sequences.

12. The method of claim 9, wherein the pairwise relations are stored in a symmetrical matrix.

13. The method of claim 1, wherein the pick sequence is rendered as a shopping list at a client device.

14. The method of claim 13, wherein the order for the items offered at the warehouse is generated by a first client device operated by a first user, and wherein the shopping list is rendered at a second client device operated by a second user.

15. A computer program product comprising a non-transitory computer readable storage medium having instructions encoded thereon that, when executed by a processor, cause the processor to:
obtain historical pick data for a plurality of items located in a warehouse, the historical pick data comprising product data for each of the items picked and pick times between each of the items picked;
determine a taxonomy of the plurality of items offered by the warehouse, the taxonomy identifying a plurality of product categories structured in a hierarchy, wherein each level of the hierarchy corresponds to a particular level of granularity of product data;
apply the historical pick data to a machine learning model to generate pairwise relations between product categories in the plurality of product categories at each level of the taxonomy;
generate a plurality of sequences of product categories based on the pairwise relations;
receive an order for items offered by the warehouse;
compare the order to at least one sequence in the plurality of sequences to generate a pick sequence for the order; and
output the pick sequence.

16. The computer program product of claim 15, wherein comparing the order to the at least one sequence comprises:
for each item in the order, identifying product data associated with the at least one sequence;
ranking each item based on a position of the identified one or more product categories of the item in the at least one sequence; and
generating the pick sequence for the order based on the ranking.

17. The computer program product of claim 16, wherein ranking each item comprises:
ranking each item based on the order of a product category of the item in a most granular sequence; and
based on determining that none of the identified product categories of the particular item are contained in the most granular sequence, estimating a ranking for the particular item based on the sequence generated one level above the most granular sequence in the hierarchy.

18. The computer program product of claim 17, wherein generating the plurality of sequences comprises:
a) selecting a particular level in the hierarchy;
b) selecting a seed from the particular level as a currently selected product category, the seed establishing a first product category in a generated sequence;
c) determining, based on the calculated pairwise relations, a shortest distance product category from the currently selected product category;
d) selecting the shortest distance product category as the currently selected product category, the currently selected product category establishing a next product category in the generated sequence; and
e) repeating steps c and d until all product categories in the particular level have been selected.

19. A system comprising:
a processor; and
a memory comprising a non-transitory computer readable storage medium having instructions encoded thereon that, when executed by a processor, cause the processor to:
receive, from a first client device, an order for items offered by a warehouse;
for each item in the order, identify product one or more product categories associated with at least one sequence in a plurality of sequences of product categories;
rank each item based on the order of the identified one or more product categories of the item in the least one sequence;
generate a pick sequence for the order based on the ranking; and
send the pick sequence to a second client device, wherein the second client device performs one or more actions based on the pick sequence.

20. The system of claim 19, wherein ranking each item comprises:
ranking each item based on the order of an identified product category of the item in a most granular sequence; and
based on determining that none of the identified product categories of the particular item are contained in the most granular sequence, estimating a ranking for the particular item based on the sequence generated one level above the most granular sequence in a hierarchy.
